(19) United States
(12) Patent Application Publication
(10) Pub. No.: US 2022/0201943 A1
(43) Pub. Date: Jun. 30, 2022

(54) Thermally controlled greenhouse system

(71) Applicant: Exotherm, Inc., Houston, TX (US)

(72) Inventors: Michael J. Parrella, Katy, TX (US); Nevil R. Ede, Westport, CT (US); Martin A. Shimko, Quechee, VT (US)

(21) Appl. No.: 17/607,162

(22) PCT Filed: Dec. 17, 2019
(86) PCT No.: PCT/US2019/066769

§ 371 Date: Oct. 28, 2021

Related U.S. Application Data
(60) Provisional application No. 62/780,535, filed on Dec. 17, 2018.

(51) Int. Cl. A01G 9/24; A01G 7/02

(52) U.S. Cl. CPC A01G 9/241; A01G 7/02; A01G 9/246

(57) ABSTRACT

Greenhouses designed for optimized thermal control are provided, incorporating various elements for controlling the temperature and air quality in the greenhouse. The greenhouses are configured with structural insulation in the roof, walls, and floor of the greenhouse which use particular materials, such as concrete, glass or polycarbonate, and design implementations for thermal control of the greenhouse. The airflow and environment in the greenhouse is also managed by providing air circulation systems controlling the fresh air flow and temperature and humidity of the air in the greenhouse.

### CROSS-REFERENCE TO RELATED APPLICATIONS

The present application claims the benefit of U.S. Provisional Patent Application No. 62/780,535 filed Dec. 17, 2018, which is hereby incorporated by reference in its entirety.

### BACKGROUND OF THE INVENTION

Industrial greenhouses have been primarily designed for labor and logistic efficiencies. However, greenhouses require consistent moisture and temperature levels for year round crop production. In hot climates or conditions, cooling is typically achieved using a combination of evaporative cooling using misting systems and venting. In cold climates or conditions, heating is typically achieved through passive insulation (i.e. double glazing) combined with an external heat source (i.e. gas, diesel, electric, biomass etc.). In many regions, day and night conditions may vary significantly in terms of temperature. Complete insulation can be achieved through the use of enclosed “greenhouses” (i.e., warehouses, concrete, steel or brick structures, etc.). However, these require active lighting for virtually all of the required light, consuming large amounts of electric power. In all cases, venting, either for required air circulation or for heat dissipation purposes involves the introduction of large amounts of new air which requires high energy and water consumption for the necessary moisture and temperature regulation.

Most conventional greenhouses 10a are constructed using a frame 11 encompassing a grow area 12 covered with a single layer of polyethylene, polycarbonate or glass, which permit the passage of light, as shown for example in FIG. 1. Venting is normally exclusively done through manual or automated roof vents 13, which open and close.

Any thermal controls are passively achieved using double lining (glazing) or enclosure materials, which may or may not permit the passage of light through the structure 11, as shown for example in the greenhouse 10b shown in FIG. 2. An extra layer of double glazing material 14 is used, which may not have a continuous air path. Regardless, the same roof venting 13 is used.

In cold climates, an alternative strategy, shown for example in FIG. 3, may be to enclose a portion (usually the side not facing in the direction of the sun) of the greenhouse 10c with solid materials 15 which do not permit the passage of light (e.g., wood, concrete, etc.), which act as insulation and a heat sink. However, this sacrifices growing space in the greenhouses 10c and increases the cost of construction. In the example of FIG. 3, only 50% of the footprint of the greenhouse 10c is usable grow space 12.

There are problems with current designs in cold conditions. Single layer designs offer little insulation, so there is significant conductive heat loss through the structure of the greenhouse when ambient (outside) air temperature is lower than the greenhouse temperature. Dual layer designs provide only passive insulation and floors of greenhouses are typically not insulated, resulting in loss of heat through conduction into the ground. Heating the environment to a required temperature is achieved through the burning of costly hydrocarbons, biomass or the consumption of electricity. Independent of construction, exchange of air for plant health (i.e., additional CO₂ content, typically three or more times per hour) means that heated air is expelled and the colder air brought in from outside at ambient temperature must be heated from ambient temperature to a temperature higher than the desired average greenhouse internal temperature prior to introduction into the greenhouse. Venting is typically effected at the high point of greenhouses (i.e., roof peaks) where air temperature is warmest, exacerbating energy loss.

There are also problems with current designs in hot conditions. Single layer designs offer little insulation, so there is significant conductive heat gain through the structure of the greenhouse when ambient air temperature is higher than greenhouse temperature. Dual layer designs provide only passive insulation. Floors of greenhouses are not thermally regulated resulting in high heat absorption through solar radiation, and heat energy is then transferred into the greenhouse environment through conduction, convention and re-radiation. Greenhouse cooling requires either misting for evaporative cooling combined with venting, which consumes a lot of fresh water and where thermal control is limited, or a conventional compressor-based air conditioning which consumes large amount of electricity. Independent of construction, exchange of air for plant health (i.e., additional CO₂ content, typically three or more times per hour) means that cooled air is expelled and hotter air brought in from outside. This significantly increases the cooling load on greenhouse systems.

In hot and cold conditions, it is common for greenhouses to have to deal with climates that are hot during the day and cold at night. Conventional, non-thermally controlled greenhouses address these conditions separately, cooling during the day and heating at night when required. This is highly inefficient from an energy perspective. In hot and cold conditions, conventional greenhouses suffer from the same design shortfalls as separately itemized for hot and cold conditions.

### SUMMARY OF THE INVENTION

Greenhouse heating and cooling costs for hot and cold climates represent the largest component of greenhouse operating costs. Designing a thermally controlled commercial greenhouse will result in significant operating cost savings.

This present application provides novel features of greenhouses designed specifically for thermal control which, when utilized individually or when aggregated, will provide the greenhouse operator with these savings. The implementation of these features in the design will not adversely impact or compromise the other greenhouse operating costs including labor, logistics, etc.

The present application includes two areas of greenhouse design, including: (1) Structural insulation with respect to the roof, walls, and floor, including design and materials used; and (2) Thermal management of the airflow and environment in the greenhouse, including (a) Recirculation rate and thermal treatment, (b) Refresh/Vented air flow rate and thermal treatment, (c) Active thermal insulation via interstitial vent air flow, and (d) Humidity control of treated refresh and recirculated air flows.

Each of these design aspects can be separately integrated into designs for hot, cold, and combined hot and cold climate conditions.

In accordance with the present application, a greenhouse system is provided comprising: flooring comprised of a first material, outer walls comprised of a second material, a roof comprised of a third material, and a thermally controlled air circulation system. As discussed herein, the materials of the flooring, outer walls and roof can vary or be the same.

In accordance with an embodiment of the greenhouse system, the first material for the flooring comprises concrete, and may also comprise one or more of melamine formaldehyde or polypropylene.

In accordance with a further embodiment of the greenhouse system, the second material for the outer walls comprises concrete, and may also comprise one or more of melamine formaldehyde or polypropylene. In an alternative embodiment, the second material of the outer walls may comprise polycarbonate, which can be substantially transparent to allow light to pass therethrough, and may comprise one or more sheets of polycarbonate. In an additional or alternative embodiment, the outer walls may further comprise glass.

In accordance with a further embodiment of the greenhouse system, which may be in addition or an alternative to the above-described embodiments, the third material for the roof comprises concrete, and may also comprise one or more of melamine formaldehyde or polypropylene. In an alternative embodiment, the third material of the roof may comprise polycarbonate, which can substantially transparent to allow light to pass therethrough. In one such embodiment, the roof comprises one or more sheets of polycarbonate, and at least one of the one or more sheets comprises a plurality of hexagonal rows running in parallel. The roof and/or the outer wall may further comprise one or more retractable shades inside the greenhouse having a black or reflective material.

In accordance with a further embodiment of the greenhouse system, which may be in addition or an alternative to the above-described embodiments, the thermally controlled air circulation system comprises one or more cooling units configured to provide a supply of cold air. The flooring may comprise one or more conduits configured to receive the supply of cold air from the one or more cooling units and a plurality vents configured to distribute the received cold air. One or more of the plurality of vents can be arranged beneath a platform affixed to the flooring.

In accordance with a further embodiment of the greenhouse system, which may be in addition or an alternative to the above-described embodiments, the thermally controlled air circulation system comprises one or more heating units configured to provide a supply of heated air. The flooring comprises one or more conduits configured to receive the supply of heated air from the one or more heating units and a plurality vents configured to distribute the received heated air. One or more of the plurality of vents are arranged beneath a platform affixed to the flooring.

In further embodiments of the greenhouse system, the thermally controlled air circulation system further comprises one or more interstitial passages comprising an open vent arranged near the roof to intake warmed air that has risen towards the roof of the greenhouse and one or more openings beneath the roof configured to output the warmed air. The one or more interstitial passages may comprise one or more additional polycarbonate sheets or panels across a length of the roof and walls of the greenhouse arranged on an interior or exterior of the greenhouse.

In still further embodiments of the greenhouse system, the thermally controlled air circulation system further comprises an air exchange unit configured to eject air from inside the greenhouse and intake external air from outside the greenhouse. The air exchange unit can be configured in communication with at least one of the one or more openings of the one or more interstitial passages and comprises at least one venting fan configured to create a negative pressure that causes the intake of the warmed air at the open vent of the interstitial passage. The air exchange unit can be configured to manage a level of CO₂ in the greenhouse. The air exchange unit can also be configured to supply air to the one or more cooling units or the one or more heating units. The air exchange unit may further comprise a desiccant wheel system configured to control humidity of air entering the greenhouse.

In accordance with a further embodiment of the greenhouse system, which may be in addition or an alternative to the above-described embodiments, the flooring comprises a base comprising the first material, a plurality of support pegs projecting a distance above the base, and a sheet of polycarbonate material placed atop the support pegs, wherein an air gap is formed between the base and the sheet of polycarbonate material. The upper surface of the sheet of polycarbonate may comprise one or more polyethylene sheets. The air gap can be ventilated to increase the flow of air comprising heat dissipated by the base to another location to decrease the amount of heat conducted from the base to the greenhouse.

### BRIEF DESCRIPTION OF THE DRAWINGS

FIG. 1 shows an example of a conventional greenhouse design having a single layer construction;

FIG. 2 shows an example of a conventional greenhouse design having a dual layer construction;

FIG. 3 shows an example of a conventional greenhouse design having an alternate insulated design for cold climates;

FIG. 4 shows a cooled insulated concrete greenhouse design according to an embodiment of the present application;

FIG. 5 shows a heated insulated concrete greenhouse design according to an embodiment of the present application;

FIG. 6 shows a cooled insulated polycarbonate greenhouse design according to an embodiment of the present application;

FIG. 7 shows a heated insulated polycarbonate greenhouse design according to an embodiment of the present application;

FIGS. 8a-8c show examples of polycarbonate roof materials in accordance with the present application;

FIG. 9a shows an example of a clear polycarbonate sheet for a greenhouse roof or wall in accordance with the present application;

FIG. 9b shows an example of a glass block for a greenhouse roof or wall in accordance with the present application;

FIG. 9c shows an example of a polycarbonate block for a greenhouse roof or wall in accordance with the present application;

FIG. 9d shows an example of greenhouse panels slotted into steel or block frames in accordance with the present application;

FIG. 10 shows a greenhouse floor in accordance with an embodiment of the present application;

FIG. 11 shows an example of a desiccant wheel operation in accordance with an embodiment of the present application;

FIG. 12 shows a greenhouse configuration in accordance with an embodiment of the present application;

FIG. 13 shows a greenhouse configuration in accordance with a further embodiment of the present application; and

FIG. 14 shows a greenhouse configuration in accordance with a further embodiment of the present application.

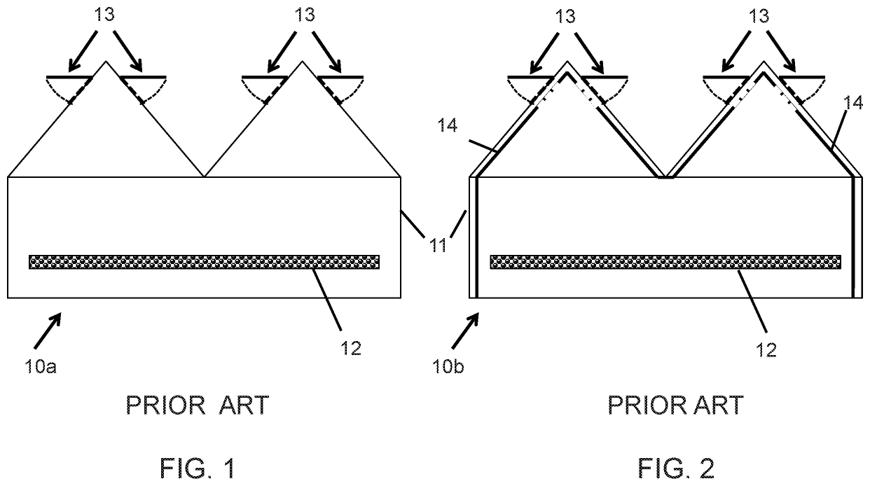

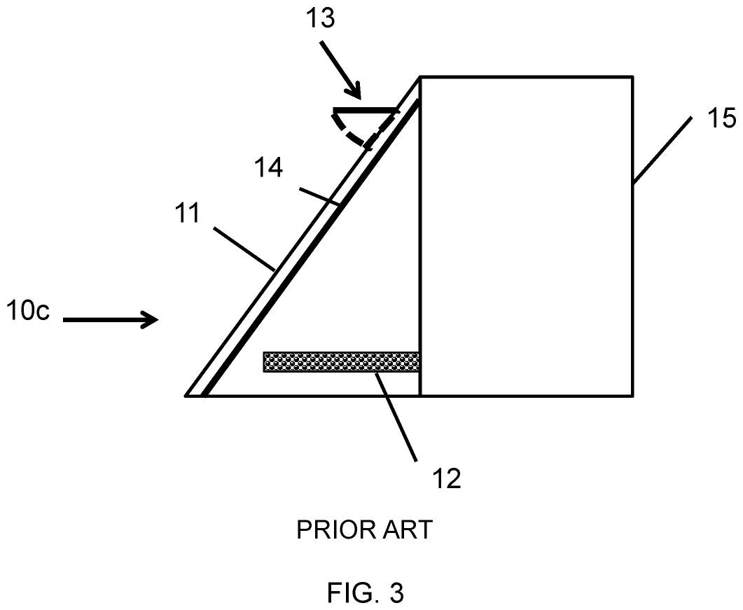

### DETAILED DESCRIPTION OF THE INVENTION

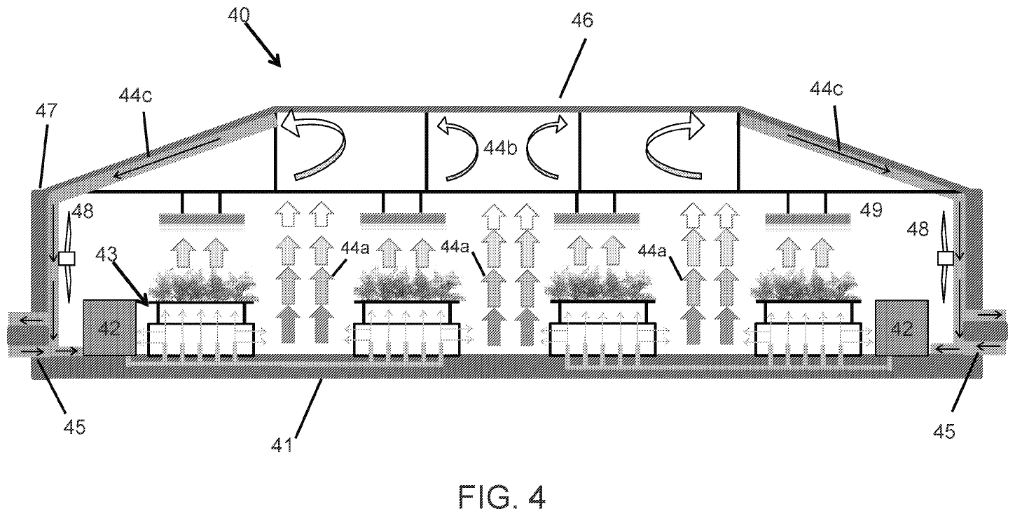

The present application will now be described with reference made to FIGS. 4-14.

Depending on climate or crop requirements, as well as other considerations such as limited sunlight and the prevalence of extreme weather conditions (e.g., hurricanes), thermally controlled greenhouse roof, floor and walls may be made of concrete.

FIG. 4 shows an exemplary embodiment of a cooled, insulated concrete greenhouse 40 in accordance with the present application, having a concrete floor 41, a concrete roof 46 and concrete walls 47. The concrete floor 41 includes conduits to allow the flow of air from cooling units 42 to raised platforms 43. The raised platforms 43 can be integrated with the floor 41 and distribute the thermally controlled air from the cooling units 42 to plants on the platforms 43 via vents. The greenhouse 40 may include a plurality of cooling units 42 and a plurality of raised platforms 43, and also includes a plurality of lighting structures 49 arranged over the raised platforms 43.

Cool air 44a rises from the floor 41 of the greenhouse 40 through the grow zone where the plants are arranged. Warmer air 44b rises towards the concrete roof 46 of the greenhouse 40, and is drawn down interstitial passages 44c of the greenhouse 40, towards air exchange points 45 at floor level. The air exchanges 45 control the amount of incoming air to the cooling units 42, and the temperature of the incoming air can be controlled through a heat exchanger and desiccant system 110, shown and described in FIG. 11. Gusting fans 48 can also be provided in the greenhouse 40 to provide circulation of a portion of the warmer interstitial air 44c through the greenhouse 40.

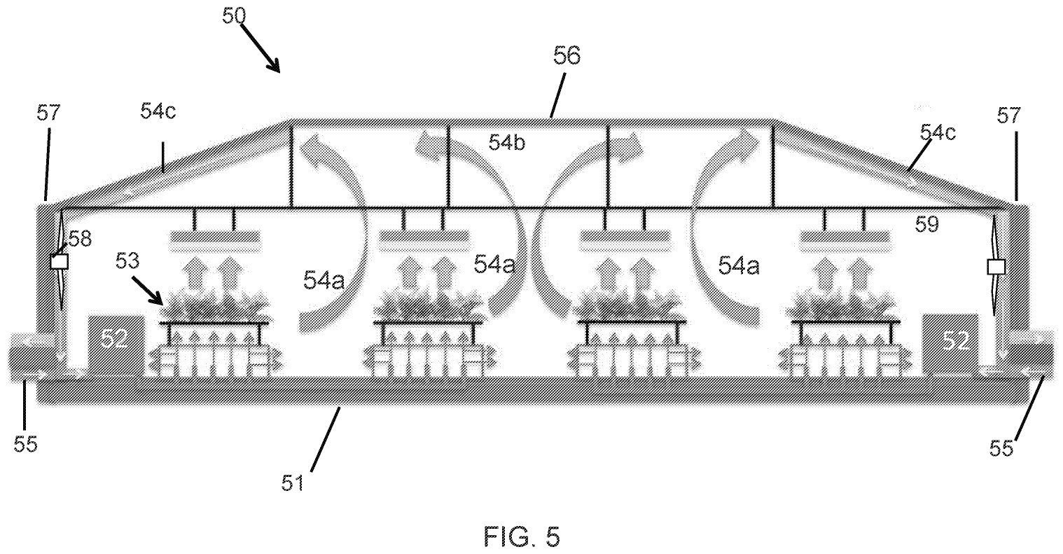

FIG. 5 shows an exemplary embodiment of a heated, insulated concrete greenhouse 50 in accordance with the present application, having a concrete floor 51, a concrete roof 56 and concrete walls 57. The concrete floor 51 includes conduits to allow the flow of air from heating units 52 to raised platforms 53. The raised platforms 53 can be integrated with the floor 51 and distribute the thermally controlled air from the heating units 52 to plants on the platforms 53 via vents. The greenhouse 50 may include a plurality of heating units 52 and a plurality of raised platforms 53, and also includes a plurality of lighting structures 59 arranged over the raised platforms 53.

Heated air 54a rises from the floor 51 of the greenhouse 50 through the grow zone where the plants are arranged. The heated air 54b rises towards the concrete roof 56 of the greenhouse 50, and is drawn down interstitial passages 54c of the greenhouse 50, towards air exchange points 55 at floor level. The air exchanges 55 control the amount of incoming air to the heating units 52, and the temperature of the incoming air can be controlled through a heat exchanger and desiccant system 110, shown and described in FIG. 11. Gusting fans 58 can also be provided in the greenhouse 50 to provide circulation of a portion of the warmer interstitial air 54c through the greenhouse 50.

Insulation capabilities of concrete may be enhanced through the use of polymers such as melamine-formaldehyde or waste thermoset plastics, including polypropylene. Additives will also make the concrete lighter. Structural capabilities of the concrete may be enhanced through the use of steel or basalt reinforcement. Additives, such as melamine-formaldehyde, will also increase structural strength.

Thermally controlled concrete structures can be used in both hot and cold climates, made to be hurricane resistant, made using modular sections for cost saving and rapid construction, stacked in multiple levels where ground space is limited, and include insulated polycarbonate windows and skylights to permit some natural light.

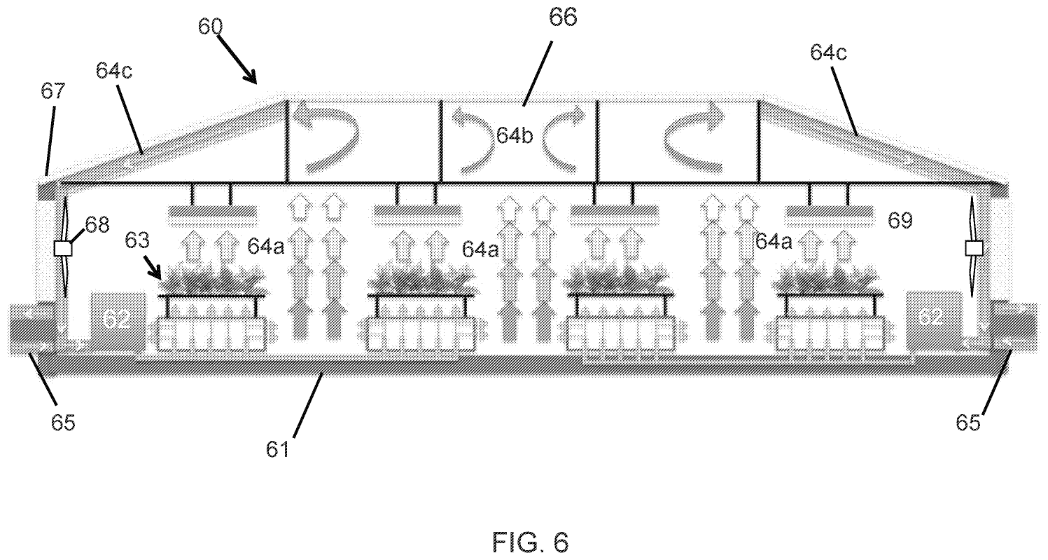

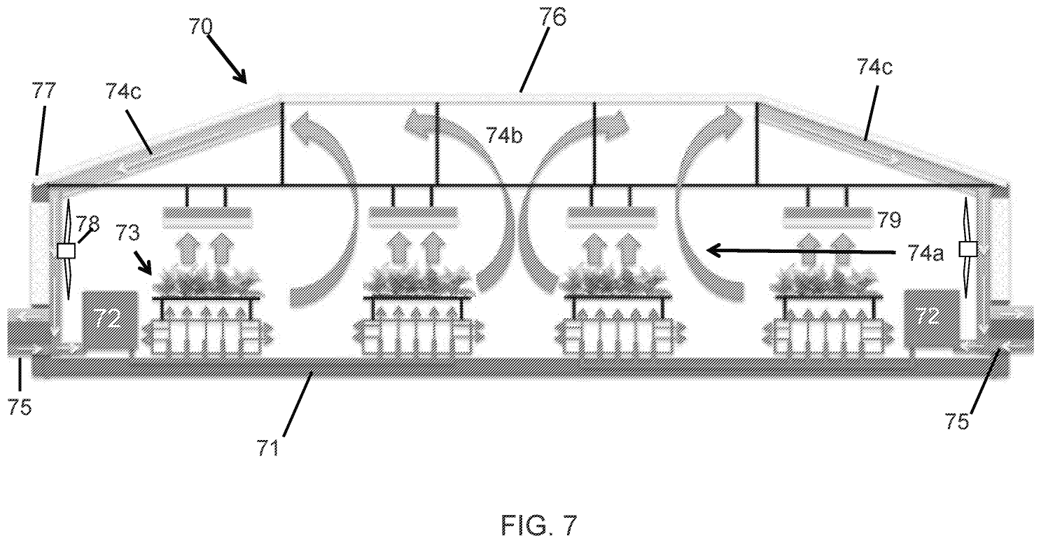

Transparent materials such as polycarbonate or glass may be used to construct thermally controlled greenhouses when abundant sunlight is available or the cost of electric power for permanent indoor lighting (as required by concrete or warehouse structures) is prohibitive. Exemplary embodiments of such greenhouses are shown in FIGS. 6 and 7.

FIG. 6 shows a cooled, insulated polycarbonate greenhouse 60 according to an embodiment of the present application. The greenhouse 60 includes a concrete floor 61 and a roof 66 made of polycarbonate materials. The walls 67 of the greenhouse 60 can be made of polycarbonate, concrete or glass, or any combination thereof. The floor 61 includes conduits to allow the flow of air from cooling units 62 to raised platforms 63. The raised platforms 63 can be integrated with the floor 61 and distribute the thermally controlled air from the cooling units 62 to plants on the platforms 63 via vents. The greenhouse 60 may include a plurality of cooling units 62 and a plurality of raised platforms 63, and also includes a plurality of lighting structures 69 arranged over the raised platforms 63.

Cool air 64a rises from the floor 61 of the greenhouse 60 through the grow zone where the plants are arranged. Warmer air 64b rises towards the concrete roof 66 of the greenhouse 60, and is drawn down interstitial passages 64c of the greenhouse 60, towards air exchange points 65 at floor level. The air exchanges 65 control the amount of incoming air to the cooling units 62, and the temperature of the incoming air can be controlled through a heat exchanger and desiccant system 110, shown and described in FIG. 11. Gusting fans 68 can also be provided in the greenhouse 60 to provide circulation of a portion of the warmer interstitial air 64c through the greenhouse 60.

FIG. 7 shows a heated, insulated polycarbonate greenhouse 70 according to an embodiment of the present application. The greenhouse 70 includes a concrete floor 71 and a roof 76 made of polycarbonate materials. The walls 77 of the greenhouse 70 can be made of polycarbonate, concrete or glass, or any combination thereof. The concrete floor 71 includes conduits to allow the flow of air from heating units 72 to raised platforms 73. The raised platforms 73 can be integrated with the floor 71 and distribute the thermally controlled air from the heating units 72 to plants on the platforms 73 via vents. The greenhouse 70 may include a plurality of heating units 72 and a plurality of raised platforms 73, and also includes a plurality of lighting structures 79 arranged over the raised platforms 73.

Heated air 74a rises from the floor 71 of the greenhouse 70 through the grow zone where the plants are arranged. The heated air 74b rises towards the concrete roof 76 of the greenhouse 70, and is drawn down interstitial passages 74c of the greenhouse 70, towards air exchange points 75 at floor level. The air exchanges 75 control the amount of incoming air to the heating units 72, and the temperature of the incoming air can be controlled through a heat exchanger and desiccant system 110, shown and described in FIG. 11. Gusting fans 78 can also be provided in the greenhouse 70 to provide circulation of a portion of the warmer interstitial air 74c through the greenhouse 70.

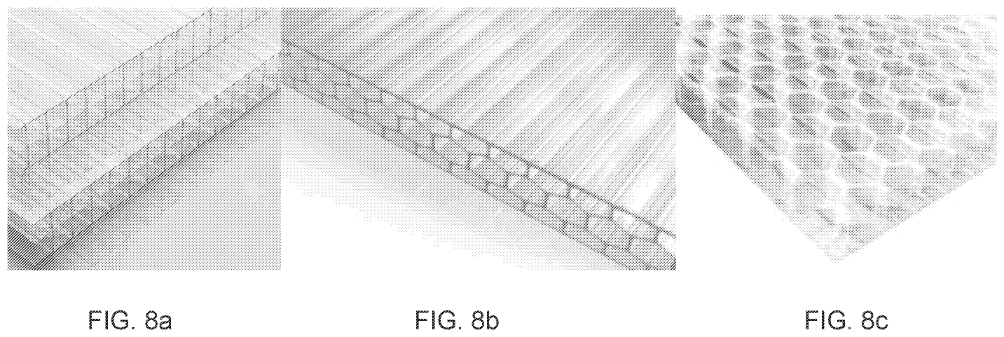

Polycarbonate can be used for thermally controlled greenhouses and offers many significant advantages over glass, including: it is lighter in weight, which enables multi-layered roofs to be supported by structural supports that are not substantial in size and therefore do not interfere with light; it is less costly to transport; it can be fabricated less expensively and efficiently into complex shapes to facilitate insulation and structural strength; (See, e.g., FIGS. 8a to 8c); it is significantly less at risk of damage from debris due to hyper-extreme weather conditions, such as tornadoes where wind speeds can reach 300 mph and significantly exceeding hurricane resistance design parameters; and it can be coated in films to block harmful components of natural light and filter unnecessary components of solar spectrum to limit unnecessary insolation.

Polycarbonate roof materials can be square, rectangular or hexagonal honeycomb sheets running either in parallel (FIGS. 8a and 8b) with or perpendicular (FIG. 8c) to the floor of the greenhouse depending on required light diffusion, insulation and strength requirements of roof structure. The hexagonal honeycomb pattern offers the greatest structural strength when combined with two flat sheets of polycarbonate to create a sandwich with the honeycomb structure forming an efficient insulating barrier. The thickness of the honeycomb sandwich will be determined by insulation level desired.

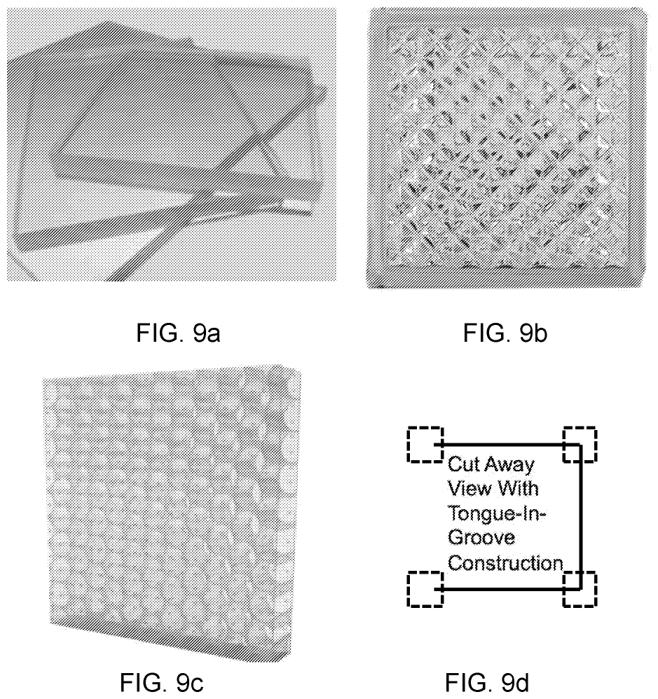

Polycarbonate roof greenhouse wall materials may be composed of flat sheets of polycarbonate or include clear polycarbonate or glass blocks, which may or may not be load bearing, as shown in FIGS. 9a, 9b and 9c. Blocks can be standalone load bearing in steel frame. Flat panels can be pre-cut and slotted into steel or block frame, as shown in FIG. 9d.

For polycarbonate greenhouses, in order to provide extra insulation at night for cold climates and to shade high levels of insolation during the hottest parts of the day in hot climates, black or reflective roll-out shades may integrated into greenhouse design (FIG. 9d).

Generally, little consideration is given to floor construction in non-thermally controlled greenhouses. The floors can be dirt, gravel, sand or concrete, based upon cost and basic operational requirements.

The thermally controlled greenhouse requires that floor design and construction be an integral part to the building's structure and thermal operating performance. In both polycarbonate and concrete structures, as described above and shown for example in FIGS. 4-7, the same floor construction designs can be used. Performance attributes of the floor may include: supporting greenhouse operations (including cleaning, heavy equipment operation, e.g., carts, fork-lifts etc.); distribution of thermal conditioning (hot and cold air and/or water) across greenhouse floor through embedded conduits; insulation; absorption/reflection of impinging insolation as appropriate; absorbed/stored heat “vented” or reintroduced at night; the floor being concrete slab to provide secure foundation for hurricane resistant frame and structure; the slab contain conduits from heat/cooling sources directly to grow tables and grow areas (as shown for example in the floors 41, 51, 61, 71 of FIGS. 4-7); a concrete slab surface can be treated for either solar absorption (colored black) or reflection (colored white or silver) depending on primary climate conditions; and a concrete slab may contain thermoset plastic content for insulation and strength.

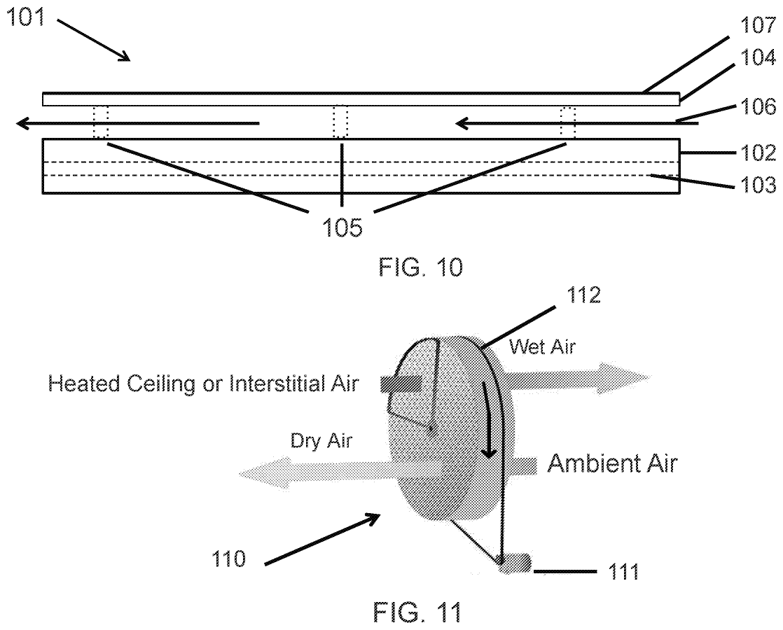

An example embodiment of flooring 101 including a concrete slab 102 with conduits 103 formed therethrough is shown in FIG. 10. In hot conditions, where heat dissipation of insolation absorbed by the concrete slab 102 may be required, a clear polycarbonate sheet 104 having a thickness of 1-2 cm may be placed above the concrete slab 102 and supported by support pegs 105 in the concrete slab 102, with an air gap 106 maintained in between the polycarbonate sheet 104 and the concrete slab 102. The low thermal conductivity of the polycarbonate sheet 104, combined with a ventilation of the air gap 106 as required, will prevent thermal conduction of heat from the slab 102 back into the greenhouse for cooling dominant situations. The surface of the polycarbonate sheet 104 may be protected by disposable clear polyethylene sheets 107.

In accordance with the present application, thermal management of the airflow in the greenhouse is also provided. The basis for cooling air includes that cooled air is delivered directly to the growing area through conduits in the floor and disseminated through floor vents or vents in the raised daises where plants are grown (e.g., platforms 43, 63 in FIGS. 4 and 6 described above). Thermally treated air will then rise through the grow zone, eventually reaching the roof, at which point it will be at its maximum temperature (e.g., warmed air 44b, 64b, in FIGS. 4 and 6 described above). The collection of the room air is collected at roof level for direct venting, interstitial heat capture, precooling refresh air, desiccant system regeneration, and/or cooling/recirculation. The cooled incoming/recirculated air can be dried using a desiccant rotating wheel system 110 to reduce/maintain proper humidity of the greenhouse air.

The basis for heating air can be similar to that described above. Heated air is delivered directly to the growing area through conduits in the floor and disseminated through floor vents or vents in the raised daises where plants are grown (e.g., platforms 53, 73 in FIGS. 5 and 7 described above). Thermally treated air will then rise through the grow zone, eventually reaching the roof, at which point it will be at its maximum temperature (e.g., warmed air 54b, 74b in FIGS. 5 and 7 described above). The collection of the room air is collected at roof level for direct venting, interstitial heat capture, precooling refresh air, desiccant system regeneration, and/or heating/recirculation. Humidity control may require inlet air misting, if refresh air is cold or dry enough to reduce the heated air humidity to unacceptably low levels.

Stored solar energy in the floor system can also be used to level thermal load variation for over twenty-four hours.

The airflow can also be managed in a thermally controlled greenhouse according to the present application. Airflow management in a thermally controlled greenhouse includes the option to perform any of the following as appropriate for the specific greenhouse thermal environment: (1) Channeling collected room air to: outside vents, interstitial passageways in the greenhouse structure, and/or insulated conduits to recirculation/treated venting plenum; (2) Managing air exchange with outside air by: supplying replenishment of fresh air to maintain required CO₂ levels, pre-cooling/pre-warming refresh air with venting air as appropriate, direct venting of interstitially heated vent air, recirculation of room air for thermal treatment and/or gusting for plant stimulation; (3) Managing the use of solar insolation stored in the flooring system; and/or (4) Regenerating the desiccant drying system, using either: roof level collected room air or interstitially warmed air.

When beneficial to thermal control, the flow path of air is controlled so that ceiling collected air 44b, 54b, 64b, 74b is directed along the boundary of greenhouse 44c, 54c, 64c, 74c. This could be in the inner wall of the greenhouse 40, 50, 60, 70, the outer wall of the greenhouse 40, 50, 60, 70, or an intermediary distance between the inner and outer layer of the of the greenhouse wall. This interstitial flow of air at the boundary of the greenhouse 40, 50, 60, 70 (i.e., the roof 46, 56, 66, 76 and walls 47, 57, 67, 77) is subject to the direct conductive thermal effect of the outside environment, even though this effect is limited by the thermal insulation provided by the greenhouse construction.

In order to achieve a continuous flow of air along either the inner or outer boundary, an interstitial passage 44c, 54c, 64c, 74c can be created by the addition of flat polycarbonate sheets or panels across the panels of the roof 46, 56, 66, 76 and uninterrupted down the side of the walls 47, 57, 67, 77. The sheets or panels can be between 0.5 and 1.0 cm thick. A mid-line interstitial flow can be created by sandwiching an air flow path between two layers of the boundary material.

Air is drawn into the interstitial passage 44c, 54c, 64c, 74c via open vents at the roof 46, 56, 66, 76 and pulled through the passage 44c, 54c, 64c, 74c by the negative pressure effect created by the venting fans of the air exchange units 45, 55, 65, 75. The interstitial passage 44c, 54c, 64c, 74c and the additional polycarbonate panel, while serving to manage air flow, also provide further insulation to the boundary layer of the greenhouse 40, 50, 60, 70. The air flow exiting the interstitial path 44c, 54c, 64c, 74c will have been heated to a higher temperature than the source ceiling air 44b, 54b, 64b, 74b. This will further lower the relative humidity of the exiting air increasing its utility in regenerating the desiccant system 110.

Since the airflow of the thermally controlled greenhouse 40, 50, 60, 70 is designed to be controlled and non-turbulent, gusting fans 48, 58, 68, 78 can be employed, such as 3-4 times per day, to move the foliage of mature plants to promote optimal growth.

The air exchange with outside air can also be managed for replenishment of fresh air and maintenance of required CO₂ levels. One or more vents 45, 55, 65, 75 are placed at the base of the walls 47, 57, 67, 77 of the greenhouse 40, 50, 60, 70, and air is drawn from either the interstitial flow path 44c, 54c, 64c, 74c or the insulated conduits prior to venting. Control software can be configured to determine how much air needs to be re-circulated and how much needs to be vented for replacement based upon CO₂ levels in the greenhouse 40, 50, 60, 70. It is beneficial that only minimum replacement levels for optimum cost efficient growth occur since incoming air will require thermal conditioning and/or moisture level management.

The energy efficient, thermally controlled greenhouse 40, 50, 60, 70 can manage the venting process so that, when thermally advantageous, the incoming air will be pre-conditioned prior to heating or cooling by passing it through an efficient air heat exchange manifold using vented air.

As described above, the floor 41, 51, 61, 71 of the greenhouse 40, 50, 60, 70 can act as both a reflector and a thermal trap for the direct solar insolation that strikes it, depending on the thermal load characteristics of the specific greenhouse and the level of utilization for trapped thermal energy.

In greenhouses with no use for stored heat overnight, such as in a pure tropical environment, the floor base can be silver or reflective to maximize the amount of solar insolation reflected back to the atmosphere, as long as the specific plants can tolerate underside reflected sunlight. The gap area is then circulated with either ambient air (or water) that is directly vented. This will keep the base surface cool and virtually eliminate re-radiation to the greenhouse. If plants cannot tolerate reflection, a black floor base can be used and the level of vented air (or water) flow increased.

In greenhouses with a large requirement for night heating, a black floor base can be used to maximize thermal storage during the day. Floor venting flow is limited to control maximal storage without excessive floor temperature and re-radiation. Air flow is recirculated overnight to transfer stored heat to the greenhouse.

In greenhouses with moderate overnight heating requirements, a black or silver floor base can be provided with controlled daytime venting and controlled night time recirculation. In greenhouses with constant heating requirements, a black floor base can be provided with constant recirculation to the room and turbulent mixing of room air to minimize floor to ceiling gradient.

The energy efficient, thermally controlled greenhouse will manage the venting process so that the incoming air will be pre-conditioned prior to heating or cooling by passing it through an efficient air heat exchange manifold using vented air when thermally advantageous. This will reduce the energy required for heating or cooling air to the desired levels. An exception to this is if the vented air is either hotter (for a cooled greenhouse) or colder (for a heated greenhouse) than the ambient air being drawn in from outside of the greenhouse by virtue of its circulation around the boundary layer of the greenhouse itself or absorption of solar insolation. In this case, control software can ensure that air is vented bypassing the heat exchange manifold.

Any air that is ultimately vented will always be heated to near ambient by either interstitial flow or in a vent air out/fresh air in heat exchanger.

For humidity control a rotating desiccant wheel system 110 will be installed following the thermal treatment section. Humidity control is usually needed in hot, moist environments where moisture needs to be removed from the treated air if the treated temperature reduction is not sufficient to lower the humidity level in the green house to the 70% level ideal for plant health. The desiccant wheel 110 includes a motor 111 and rotor 112, and its operation is shown in FIG. 11. The desiccant wheel 110 uses the heated air from either the ceiling vents via the insulated ducting (if it is hot enough) or interstitial air flow to regenerate the desiccant wheel 110. The control system will determine the flow amount of air from either source needed to regenerate the desiccant wheel to a level required to keep humidity levels acceptable.

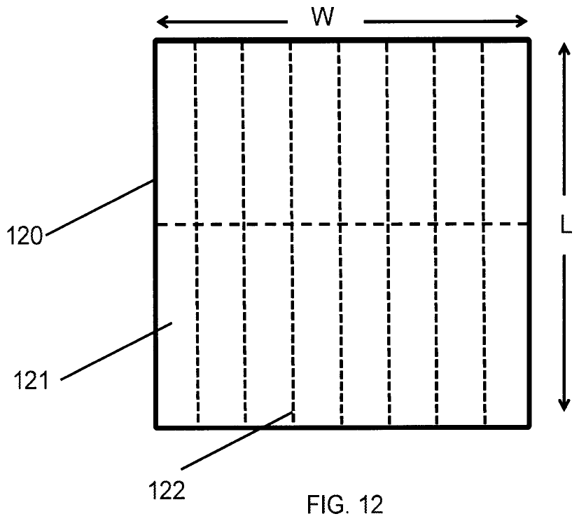

Additional exemplary greenhouse configurations are illustrated in FIGS. 12-14.

FIG. 12 shows an example configuration of a greenhouse module 120 having a width (W) and length (L) of 200 feet with a grow space 121 arranged therein. In a total space of one acre, Greenhouse module covers approximately 90% of the total acreage, while providing the remainder is access. Separate space can be set aside for administration, processing, solar farming, storage and other purposes. Gutter lines 122 for water collection can be provided between roof gables.

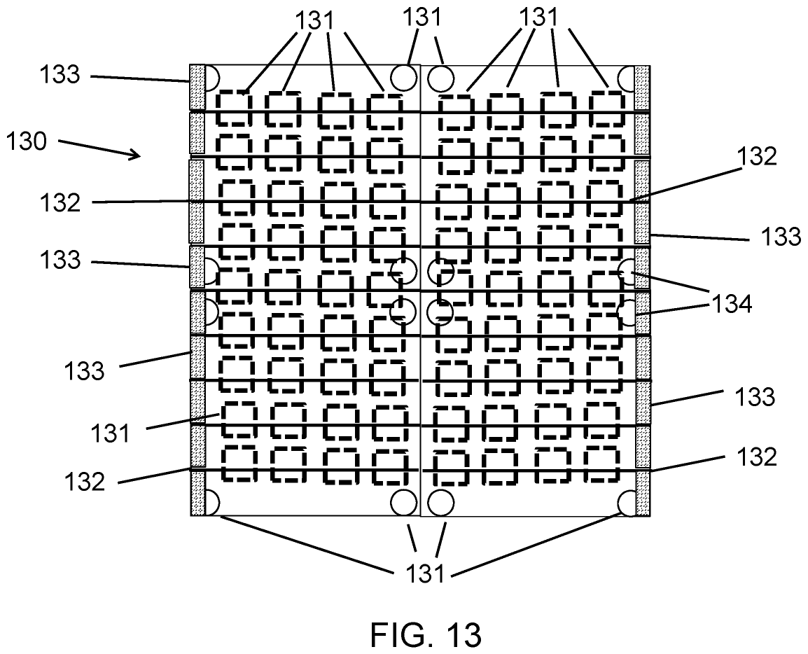

FIG. 13 shows a further example of a configuration of a greenhouse module 130. The thermally controlled greenhouse module 130 is an open plan to permit air circulation and efficient lighting by light fixtures 131. The light fixtures 131 can be raised or lowered as required and LED lighting can be used to reduce energy consumption, as well as reduce thermal load for a cooled greenhouse, and LED light frequencies can be optimized for specific crops. Lighting supports, such as steel support beams 132, allow for automated shade rollout using rolled screens 133 for polycarbonate greenhouses, to affect complete blackout when required. Shades 133 can also be reflective to allow for shading at hottest time of day in high heat environments. The greenhouse module 130 also may include a plurality of heating or cooling units 134 arranged throughout the greenhouse.

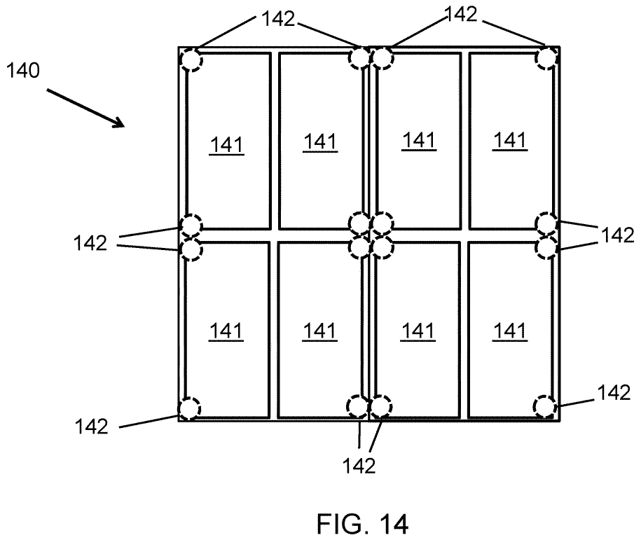

FIG. 14 shows a further example of a configuration of a greenhouse module 140, which may have dimensions of 200 feet by 200 feet. The layout is designed to maximize grow space in single level configuration of growing tables 141, with sufficient space in the aisles to allow machinery to enter and egress. The greenhouse module 140 also may include a plurality of heating or cooling units 142 arranged throughout the greenhouse.

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

1. A greenhouse system comprising:
flooring comprised of a first material;
outer walls comprised of a second material;
a roof comprised of a third material; and
a thermally controlled air circulation system.

2. The greenhouse system according to claim 1, wherein the first material comprises concrete.

3. The greenhouse system according to claim 2, wherein the first material further comprises one or more of melamine formaldehyde or polypropylene.

4. The greenhouse system according to claim 1, wherein the second material comprises concrete.

5. The greenhouse system according to claim 4, wherein the second material further comprises one or more of melamine formaldehyde or polypropylene.

6-7. (canceled)

8. The greenhouse system according to claim 1, wherein the outer walls comprise one or more sheets of polycarbonate.

9. The greenhouse system according to claim 1, wherein the outer walls further comprise glass.

10. The greenhouse system according to claim 1, wherein the third material comprises concrete.

11. The greenhouse system according to claim 10, wherein the third material further comprises one or more of melamine formaldehyde or polypropylene.

12.-13. (canceled)

14. The greenhouse system according to claim 1, wherein the roof comprises one or more sheets of polycarbonate, and at least one of the one or more sheets comprises a plurality of hexagonal rows running in parallel.

15. The greenhouse system according to claim 14, wherein the roof or the outer wall further comprises one or more retractable shades inside the greenhouse having a black or a reflective material.

16. The greenhouse system according to claim 1, wherein the thermally controlled air circulation system comprises one or more cooling units configured to provide a supply of cold air and one or more heating units configured to provide a supply of heated air.

17.-21. (canceled)

22. The greenhouse system according to claim 16, wherein the thermally controlled air circulation system further comprises one or more interstitial passages comprising an open vent arranged near the roof to intake warmed air that has risen towards the roof of the greenhouse and one or more openings beneath the roof configured to output the warmed air.

23. The greenhouse system according to claim 22, wherein the one or more interstitial passages comprise one or more additional polycarbonate sheets or panels across a length of the roof and walls of the greenhouse arranged on an interior or exterior of the greenhouse.

24. The greenhouse system according to claim 16, wherein the thermally controlled air circulation system further comprises an air exchange unit configured to eject air from inside the greenhouse and intake external air from outside the greenhouse; and
wherein the air exchange unit is configured in communication with at least one of the one or more openings of the one or more interstitial passages and comprises at least one venting fan configured to create a negative pressure that causes the intake of the warmed air at the open vent of the interstitial passage.

25. (canceled)

26. The greenhouse system according to claim 24, wherein the air exchange unit is configured to manage a level of CO₂ in the greenhouse.

27. (canceled)

28. The greenhouse system according to claim 24, wherein air exchange unit further comprises a desiccant wheel system configured to control humidity of air entering the greenhouse.

29. The greenhouse system according to claim 1, wherein the flooring comprises:
a base comprising the first material;
a plurality of support pegs projecting a distance above the base; and
a sheet of polycarbonate material placed atop the support pegs;
wherein an air gap is formed between the base and the sheet of polycarbonate material.

30. The greenhouse system according to claim 29, wherein an upper surface of the sheet of polycarbonate comprises one or more polyethylene sheets.

31. The greenhouse system according to claim 29, wherein the air gap is ventilated to increase the flow of air comprising heat dissipated by the base to another location to decrease the amount of heat conducted from the base to the greenhouse.
